(19) United States
(12) Patent Application Publication
(10) Pub. No.: US 2026/0339304 A1
(43) Pub. Date: Oct. 29, 2026

(54) METHOD, SYSTEM, AND APPARATUS FOR DYNAMIC ADJUSTMENT OF MULTI-OBJECTIVE JOB SHOP SCHEDULING BASED ON LARGE MODELS

(71) Applicant: Huazhong University of Science and Technology, Hubei (CN)

(72) Inventors: Xinyu Li, Hubei (CN); Zhendong Chen, Hubei (CN); Liang Gao, Hubei (CN); Jin Huang, Hubei (CN); Qihao Liu, Hubei (CN)

(73) Assignee: Huazhong University of Science and Technology, Hubei (CN)

(21) Appl. No.: 19/344,531

(22) Filed: Sep. 30, 2025

(30) Foreign Application Priority Data
Apr. 27, 2025 (CN) 202510536393.6

(51) Int. Cl. G05B 19/418

(52) U.S. Cl. CPC G05B 19/41865; G05B 19/41885

(57) ABSTRACT

The present disclosure provides a method, a system, and an apparatus for dynamic adjustment of multi-objective job shop scheduling based on large models. The method includes: receiving job shop modeling prompt information; obtaining multiple objective weight coefficients corresponding to multiple objective demands by a large model for multi-objective weight optimization; extracting constraint conditions by a large model for mathematical modeling, and performing modeling based on the objective weight coefficients and the constraint conditions to obtain a multi-objective mathematical model; solving the multi-objective mathematical model and outputting a job shop scheduling result; and monitoring a job shop dynamic event in real time, receiving dynamic prompt information, dynamically updating the objective weight coefficients by the large model for multi-objective weight optimization, dynamically updating the constraint conditions by the large model for mathematical modeling, continuously updating to obtain a new multi-objective mathematical model, and solving to output a new job shop scheduling result.

### CROSS-REFERENCE TO RELATED APPLICATION

This application claims the priority benefit of China application serial no. 202510536393.6, filed on Apr. 27, 2025. The entirety of the above-mentioned patent application is hereby incorporated by reference herein and made a part of this specification.

### BACKGROUND

### Technical Field

The present disclosure relates to the field of industrial automation technologies, and in particular, to a method, a system, and an apparatus for dynamic adjustment of multi-objective job shop scheduling based on collaborative driving of a plurality of large models, which are particularly applicable to complex job shop scheduling scenarios with dynamic events and multi-objective demands in the processing process.

### Description of Related Art

In the existing mechanical processing industry, the production mode generally features multiple varieties and small batches. Although the production scheduling scale is relatively small, there are higher requirements for the flexibility and accuracy of scheduling.

Most of the existing job shop scheduling methods rely on human experience or fixed mathematical models. Despite a certain flexibility, human experience-based scheduling is inefficient and susceptible to human interference, resulting in frequent scheduling errors. Although fixed mathematical models can theoretically provide a better job shop scheduling scheme, they are inadequate in dealing with complex constraints and dynamic changes in actual production. Moreover, the construction and adjustment of these fixed mathematical models often require a lot of expert knowledge. For small and medium-sized enterprises, the application cost remains high, and it is difficult to adapt to the rapid changes in production demands.

In addition, the conventional fixed mathematical model not only needs to be manually adjusted frequently in the solving process, but also faces the problem of dataset switching, which greatly reduces the adjustment efficiency, leading to low production scheduling efficiency and making it difficult to fit the actual production pace. Although the deep reinforcement learning (DRL) method has made some achievements in improving the solving efficiency, its solving result is still far away from the optimal solution, and cannot effectively meet the goal of cost reduction and efficiency improvement. Especially in the case of sudden dynamic events such as machine failures and changes in order demands, the existing job shop scheduling methods are difficult to make effective adjustments quickly, which leads to production delays and rising costs, thereby seriously weakening the production efficiency and market competitiveness of enterprises.

At present, most of the job shop scheduling methods based on large-model automatic modeling technology are limited to constructing and solving static scheduling models, and can only deal with scheduling problems in a static environment, but cannot solve the problem of dynamic event changes in the job shop production process. In actual production, job shop conditions change in real time, such as machine operating status and order urgency, which requires the scheduling model to respond in real time and dynamically adjust the scheme. However, when faced with dynamic events in the production process, the static scheduling model cannot dynamically adjust the model in time and accurately, and manual intervention is still needed to reacquire the problem description for modeling and solving to adapt to the new condition, which is time-consuming, labor-intensive, and inefficient. In this case, it is difficult to ensure the real-time performance and accuracy of the job shop scheduling result, and it cannot meet the dynamic demands of actual job shop production.

In addition, there are also multi-objective demands in the job shop scheduling, that is, there is often more than one objective demand. In addition to minimizing the time for completing the production, there are also mixed objectives composed of other objective demands such as the minimum total delay period and the minimum machine load, and these mixed objectives require frequent adjustments to the weight coefficients and proportions. For example, users want to make machine processing tasks more balanced while minimizing the time for completing the production. However, when processing these mixed objectives, the existing method not only cannot automatically adjust and optimize the multi-objective weight according to user demands, resulting in the failure to consider other objective demands when achieving one objective demand, but also needs the user to manually adjust the weight coefficient according to experience when adjusting the multi-objective weight, which lacks flexibility, subjectivity, and adaptability.

Therefore, there is an urgent need for a method for dynamic adjustment of job shop scheduling, which not only adapts to complex and changeable dynamic production environments and efficiently and dynamically processes various constraint conditions, but also has an excellent capability for automatic processing of multi-objective demands and a user interaction function to truly achieve the intelligence, automation, and personalization of job shop scheduling.

### SUMMARY

In view of the above problems, the present disclosure provides a method, a system, and an apparatus for dynamic adjustment of multi-objective job shop scheduling based on large models, which are used for solving the problem that the current job shop scheduling cannot adapt to complex and changeable actual dynamic production environments and lacks the capability for automatic processing of multi-objective demands.

In a first aspect, the present disclosure provides a method for dynamic adjustment of multi-objective job shop scheduling based on large models. The method includes:
receiving job shop modeling prompt information input by a user;
extracting a plurality of objective demands from the job shop modeling prompt information by using a large model for multi-objective weight optimization, and determining a plurality of objective weight coefficients corresponding to the plurality of objective demands;
extracting constraint conditions from the job shop modeling prompt information by using a large model for mathematical modeling, and performing modeling based on the plurality of objective weight coefficients and the constraint conditions to obtain a multi-objective mathematical model;
solving the multi-objective mathematical model to output a job shop scheduling result; and
monitoring a job shop dynamic event in real time, receiving dynamic prompt information input by the user, dynamically updating the objective weight coefficients by using the large model for multi-objective weight optimization, dynamically updating the constraint conditions by using the large model for mathematical modeling, continuously updating to obtain a new multi-objective mathematical model, and solving to output a new job shop scheduling result, thereby achieving dynamic adjustment of job shop scheduling.

Further, establishment of the large model for multi-objective weight optimization includes:
generating a fine-tuning dataset, where the fine-tuning dataset includes a plurality of groups of input indicators and output values with a mapping relationship, where
obtaining of the input indicators includes: collecting a sample dataset of a plurality of job shop schedules and a plurality of objective demands corresponding to the sample dataset, generating a job shop scheduling result corresponding to the sample dataset by using a plurality of job shop scheduling rules, and extracting dataset features from the job shop scheduling result; and taking the dataset features and the plurality of corresponding objective demands as the input indicators; and
obtaining of the output values includes: setting weight coefficients for different objective demands in the input indicators, and obtaining an optimal weight coefficient combination that balances the plurality of objective demands through an experiment of different objective weight coefficients; and using a plurality of objective weight coefficients in the optimal weight coefficient combination as the output values; and
training a large model by using the mapping relationship, inputting the input indicators and the plurality of objective weight coefficients output correspondingly into the large model by using a supervised fine-tuning method, and continuously adjusting training parameters to obtain the large model for multi-objective weight optimization.

Further, the dynamic adjustment further includes:
when updating the multi-objective mathematical model, retrieving the original constraint conditions, determining an adjustment method as retaining, modifying, or adding, and updating only part of the constraint conditions that have been changed, by the large model for mathematical modeling; and
when updating solving data, freezing to-be-processed data of incomplete processes in current job shop scheduling, removing processing data of completed processes, and outputting a new job shop scheduling result according to the dynamic prompt information input by the user and the to-be-processed data.

Further, obtaining of the multi-objective mathematical model includes:
obtaining a plurality of groups of corresponding constraint conditions according to the plurality of objective demands, and constructing a plurality of mathematical sub-models according to a single objective demand and corresponding constraint conditions separately; and
obtaining the multi-objective mathematical model by using the plurality of objective weight coefficients and the plurality of corresponding mathematical sub-models.

Further, obtaining of the mathematical sub-model includes:
establishing a job shop scheduling knowledge base, where the job shop scheduling knowledge base includes: problem definitions, variable definitions, specification constraint conditions, and corresponding LaTeX formulas of job shop scheduling; and
based on modeling knowledge stored in the job shop scheduling knowledge base, mapping the constraint conditions after fuzzification processing to specification constraint conditions in the job shop scheduling knowledge base by using the large model for mathematical modeling through retrieval, matching, and adaptation operations, and then transforming the specification constraint conditions into LaTeX formulas conforming to specifications of a mixed-integer linear programming model.

Further, establishment of the large model for mathematical modeling includes:
collecting a plurality of problem descriptions about the job shop modeling prompt information and corresponding job shop types, and using prompt words to enable a cloud-based large model to perform fuzzification processing on the problem descriptions, so as to obtain a sample dataset; and
using the sample dataset to perform supervised fine-tuning on a large model to enhance understanding and judgment of the large model on the fuzzy descriptions, so as to obtain the large model for mathematical modeling.

Further, the solving includes:
transforming the multi-objective mathematical model into code by using a large model for code construction after supervised fine-tuning, converting LaTeX formulas into Python code by using specific prompt words, and running the Python code by using a solver for solving.

Further, the job shop modeling prompt information includes at least: job shop scheduling scenario information, job shop production information, production objective demand information, and processing data.

In a second aspect, the present disclosure provides a system for dynamic adjustment of multi-objective job shop scheduling based on large models, configured to perform the steps of the method according to any one of the above embodiments, where the system includes:
a front-end interaction module, configured to receive job shop modeling prompt information or dynamic prompt information input by a user, implement information interaction between the user and the system, and display a model construction process, a solving log, and a job shop scheduling result;
a data conversion module, configured to automatically convert processing data in the job shop modeling prompt information or the dynamic prompt information from a non-standard format into a standard data format;
a large model for multi-objective weight optimization, configured to extract a plurality of objective demands from the job shop modeling prompt information, and determine a plurality of objective weight coefficients corresponding to the plurality of objective demands;
a large model for mathematical modeling, configured to extract constraint conditions from the job shop modeling prompt information, and perform modeling based on the plurality of objective weight coefficients and the constraint conditions to obtain a multi-objective mathematical model;
a code construction module, configured to transform the multi-objective mathematical model into executable code;
a solving module, configured to solve the executable code; and
a data update module, configured to, when a dynamic event occurs, based on a current processing condition and the dynamic prompt information input by the user, freeze current processing status data, remove completed process data, and generate a new dataset by combining new data and incomplete process data, so as to provide accurate data support for model solving and ensure reliability of a solving result.

In a third aspect, the present disclosure provides an apparatus for dynamic adjustment of multi-objective job shop scheduling based on large models, configured to perform the steps of the method according to any one of the above embodiments, and including a data information storage and processing device, a high-performance graphics processing unit (GPU) device, and a control device.

In general, the present disclosure provides a method, a system, and an apparatus for dynamic adjustment of multi-objective job shop scheduling based on large models. Compared with the prior art, the technical solutions of the present disclosure can achieve the following beneficial effects:
(1) According to the present disclosure, a large model for multi-objective weight optimization and a large model for mathematical modeling are introduced to construct a multi-objective mathematical model; by using the collaborative driving of the plurality of large models and the natural understanding and generation capabilities of the plurality of large models, and by combining the knowledge base in the professional field of job shop scheduling, a plurality of objective weight coefficients and constraint information can be automatically determined from fuzzy descriptions and a multi-objective mathematical model is constructed. In this way, the whole process is in a dynamically adjustable state. In addition, the user can perform multiple rounds of interaction through the interactive interface and dynamically update the multi-objective mathematical model by supplementing and adjusting the prompt information, which not only reduces the threshold and cost of modeling, but also avoids the need for the user to manually adjust the weight coefficients based on experience. The present disclosure features functions such as automatic model adjustment, automatic data conversion, and multi-objective demand adaptive modeling, which can solve the problem that the current job shop scheduling cannot adapt to complex and changeable actual dynamic production environments and lacks the capability for automatic processing of multi-objective demands, and bring new breakthroughs and development to the field of job shop scheduling.
(2) According to the present disclosure, a multi-objective weight coefficient adaptive adjustment mechanism is introduced, and prompt information input by the user is analyzed; by extracting multi-dimensional objective demands and inputting the same into a large model by combining dataset features, appropriate objective weight coefficients can be automatically determined, so as to achieve the intelligent modeling of multi-objective job shop scheduling, thereby avoiding dependence on expert experience to specify objective weight coefficients, and solving the problem of inflexible adjustment of weight coefficients in multi-objective optimization.
(3) According to the present disclosure, a dynamic event adaptive method for job shop scheduling based on large models is provided, which can automatically adjust the mixed-integer linear programming and switch the dataset by monitoring job shop dynamic events in real time, for example, job shop production conditions, machine failures, and urgent orders, update to obtain a new multi-objective mathematical model, and then solve to output a new job shop scheduling result, thereby greatly improving the real-time performance and accuracy of job shop scheduling, and solving the problem of poor adaptability of the existing job shop scheduling in the face of dynamic events.
(4) According to the present disclosure, a special interactive interface is provided, such that the user can clearly view the model construction process, the solving log, and the job shop scheduling result; meanwhile, the user can view, modify, and feed back immediately to the system the variables, the constraint conditions, and the objective function in the model, which improves the engagement and satisfaction of the user, and solves the problem in the prior art that the user interaction is not intuitive.

### BRIEF DESCRIPTION OF THE DRAWINGS

In order to more clearly illustrate the technical solutions in the present disclosure or in the prior art, the drawings required to be used in the description of embodiments or the prior art are briefly introduced below. It is obvious that the drawings in the description below are some embodiments of the present disclosure, and those of ordinary skills in the art can obtain other drawings according to these drawings without creative efforts.

FIG. 1 is a schematic diagram of method steps according to a method, a system, and an apparatus for dynamic adjustment of multi-objective job shop scheduling based on large models of the present disclosure.

FIG. 2 is a schematic diagram of training of a large model for multi-objective weight optimization according to a method, a system, and an apparatus for dynamic adjustment of multi-objective job shop scheduling based on large models of the present disclosure.

FIG. 3 is a schematic flowchart of a front-end interactive interface confirming whether prompt information meets requirements through multiple rounds of interaction with a user according to a method, a system, and an apparatus for dynamic adjustment of multi-objective job shop scheduling based on large models of the present disclosure.

FIG. 4 is a schematic diagram of a prompt word framework used for extracting constraint conditions according to a method, a system, and an apparatus for dynamic adjustment of multi-objective job shop scheduling based on large models of the present disclosure.

FIG. 5 is a schematic flowchart of data format conversion by a large model for data processing according to a method, a system, and an apparatus for dynamic adjustment of multi-objective job shop scheduling based on large models of the present disclosure.

FIG. 6 is a schematic diagram of data format conversion according to a method, a system, and an apparatus for dynamic adjustment of multi-objective job shop scheduling based on large models of the present disclosure.

FIG. 7 is a schematic diagram of a prompt word framework used in a large model for mathematical modeling according to a method, a system, and an apparatus for dynamic adjustment of multi-objective job shop scheduling based on large models of the present disclosure.

FIG. 8 is a schematic diagram of content of a modeling result output by a large model for mathematical modeling according to a method, a system, and an apparatus for dynamic adjustment of multi-objective job shop scheduling based on large models of the present disclosure.

FIG. 9 is a schematic diagram of content of code output by a large model for code construction according to a method, a system, and an apparatus for dynamic adjustment of multi-objective job shop scheduling based on large models of the present disclosure.

FIG. 10 is a Gantt chart before processing a dynamic event according to a method, a system, and an apparatus for dynamic adjustment of multi-objective job shop scheduling based on large models of the present disclosure.

FIG. 11 is a flowchart of automatic adjustment of a multi-objective mathematical model in response to a dynamic event according to a method, a system, and an apparatus for dynamic adjustment of multi-objective job shop scheduling based on large models of the present disclosure.

FIG. 12 is a schematic diagram of processing a machine failure dynamic event according to a method, a system, and an apparatus for dynamic adjustment of multi-objective job shop scheduling based on large models of the present disclosure.

FIG. 13 is a flow chart of automatic data update in response to a dynamic event according to a method, a system, and an apparatus for dynamic adjustment of multi-objective job shop scheduling based on large models of the present disclosure.

FIG. 14 is a schematic diagram of updating a machine failure dynamic event dataset according to a method, a system, and an apparatus for dynamic adjustment of multi-objective job shop scheduling based on large models of the present disclosure.

FIG. 15 is a Gantt chart after processing a dynamic event according to a method, a system, and an apparatus for dynamic adjustment of multi-objective job shop scheduling based on large models of the present disclosure.

FIG. 16 is a schematic diagram of a system structure according to a method, a system, and an apparatus for dynamic adjustment of multi-objective job shop scheduling based on large models of the present disclosure.

FIG. 17 is a schematic diagram of an apparatus structure according to a method, a system, and an apparatus for dynamic adjustment of multi-objective job shop scheduling based on large models of the present disclosure.

### DESCRIPTION OF THE EMBODIMENTS

In order to make the objectives, technical solutions, and advantages of the present disclosure clearer, the technical solutions in the present disclosure will be clearly and completely described with reference to the drawings and embodiments in the present disclosure. It is obvious that the described embodiments are some, but not all, embodiments of the present disclosure. Based on the embodiments of the present disclosure, all other embodiments obtained by those of ordinary skills in the art without creative efforts shall fall within the protection scope of the present disclosure.

It should be noted that in the description of the embodiments of the present disclosure, the terms “comprise”, “include”, or any other variants thereof are intended to cover non-exclusive inclusion, such that a method, step, or apparatus including a series of elements includes not only those elements but also other elements not explicitly listed, or elements inherent to such method, step, or apparatus. Without further limitation, an element defined by the phrase “including a . . . ” does not exclude the presence of additional identical elements in the method, step, or apparatus that includes the element.

Given the limitations in the prior art, especially the problem that the current job shop scheduling cannot adapt to complex and changeable actual dynamic production environments and lacks the capability for automatic processing of multi-objective demands, the present disclosure provides a method, a system, and an apparatus for dynamic adjustment of multi-objective job shop scheduling based on large models, which aim to solve the problem in the prior art of being unable to effectively address dynamic events such as sudden machine failures and urgent orders in the job shop production process. In addition to minimizing the time for completing the production, there may be a mixed objective problem composed of other objective demands such as the minimum total delay period and the minimum machine load.

By automatically establishing and adjusting the multi-objective mathematical model and combining a friendly user interaction interface, the present disclosure achieves the automation of the whole process from fuzzy description to model construction, code generation, and scheduling solving and provides a more flexible, efficient, and accurate solution for job shop scheduling, thereby effectively improving production efficiency and resource utilization and meeting the demands of modern manufacturing for intelligent and automated job shop scheduling.

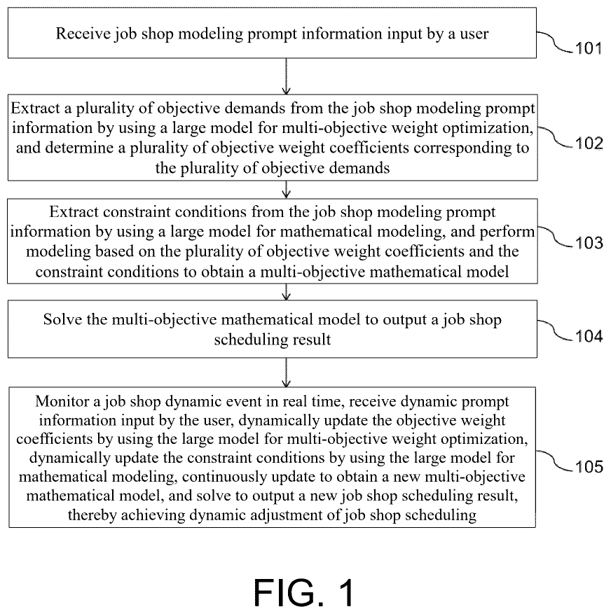

In a first aspect, as shown in FIG. 1, the method according to the present disclosure includes the following steps.

In step 101, job shop modeling prompt information input by a user is received.

Further, the job shop modeling prompt information includes at least: job shop scheduling scenario information, job shop production information, production objective demand information, and processing data.

The job shop scheduling scenario information refers to related background information such as production task arrangement, equipment usage, and personnel allocation in the job shop, and reflects the organization and coordination of job shop production activities. For example, some tasks may be given a high priority due to urgent customer demands. For example, when a customer requests that a batch of critical components for a medical device be delivered within three days, these tasks are then prioritized for production. For example, there are 10 lathes, and based on parameters such as the model, power, and maximum processing size of each lathe, appropriate processing tasks are assigned according to the device's processing capabilities. For example, there are workers with different skill levels in a job shop, such as senior technicians, intermediate technicians, and elementary technicians. The processing of a precise part may require a senior technician to operate the computer numerical control lathe. Job shop scheduling needs to consider various factors such as task priority, equipment usage, and personnel skill matching.

The job shop production information is various types of data generated in the job shop production process, and reflects the real-time status and historical situation of production activities, for example, generation progress, quality information, and device operating status.

The production objective demand information refers to objective demands set for job shop production based on market demands, order requirements, etc., including product types, numbers, quality delivery time, etc. For example, minimizing the time for completing the production, minimizing the total delay period, minimizing the machine load, and various objective demands are included.

The job shop scheduling scenario information, the job shop production information, and the production objective demand information are used to extract constraints and establish a mathematical model.

The production processing data is data related to solving, including the number of workpieces and machines, the processing corresponding relationship between the workpieces and the machines, the processing time, and the like, and is used for determining objective weight coefficients and solving a multi-objective mathematical model through code.

The method for obtaining the job shop modeling prompt information is as follows: A front-end interactive interface can be used to guide the user to describe the job shop scheduling scenario, the job shop production, and the production objective demands, and upload the production processing data as the job shop modeling prompt information.

In step 102, a plurality of objective demands are extracted from the job shop modeling prompt information by using a large model for multi-objective weight optimization, and a plurality of objective weight coefficients corresponding to the plurality of objective demands are determined.

In other words, if the user requests the establishment of a multi-objective model, multi-dimensional objective demand indicators in the job shop modeling prompt information need to be extracted, and the multi-objective weight coefficients are automatically determined by using the fine-tuned large model for multi-objective weight optimization.

As an embodiment, the establishment of the large model for multi-objective weight optimization includes the following steps.

In S201, a fine-tuning dataset is generated, where the fine-tuning dataset includes a plurality of groups of input indicators and output values with a mapping relationship.

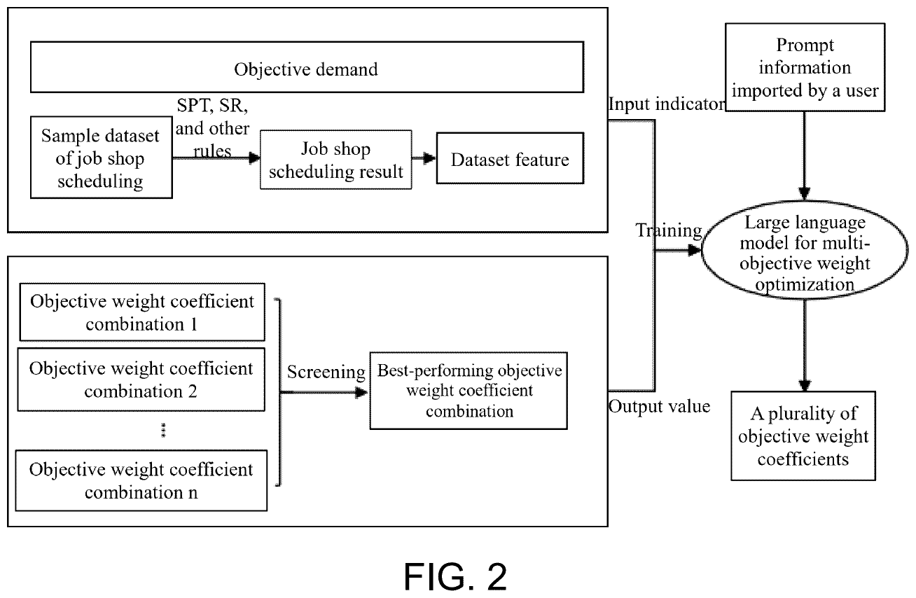

A plurality of fine-tuning datasets of job shop scheduling, used for multi-objective weight optimization fine-tuning, are created, where the fine-tuning dataset includes input indicators-output values with a mapping relationship, as shown in FIG. 2. For example, if a sample dataset has two objective demands and a high-quality weight is obtained through experiments, the input indicators are the two objective demands and the dataset features of the sample dataset, and the output values are the plurality of objective weight coefficients, so as to form the mapping relationship.

Different sample datasets and different objective demands are combined to generate a fine-tuning dataset, and the structure of the obtained fine-tuning dataset is as follows:
{Input: dataset feature 1; objective 1; objective 2
Output: weight coefficient combination 1}
{Input: dataset feature 1; objective 1; objective 3
Output: weight coefficient combination 2}
{Input: dataset feature 2; objective 1; objective 2
Output: weight coefficient combination 3}
{
. . . }.

The obtaining of the input indicators includes: collecting a sample dataset of a plurality of job shop schedules and a plurality of objective demands corresponding to the sample dataset, generating a job shop scheduling result corresponding to the sample dataset by using a plurality of job shop scheduling rules, and extracting dataset features from the job shop scheduling result; and taking the dataset features and the plurality of corresponding objective demands as the input indicators.

First, a sample dataset of a plurality of job shop schedules and a plurality of objective demands corresponding to the sample dataset need to be collected. The sample dataset consists of a plurality of groups of production data from a plurality of job shops for production. For each group of production data, a plurality of job shop scheduling rules are used to extract a job shop scheduling result, such as a production scheduling result, and some data extracted from the job shop scheduling result is used to obtain dataset features.

The job shop scheduling rules include rules such as selecting a workpiece having the shortest processing time (SPT) and selecting a workpiece having the shortest remaining processing time (SR). The dataset features include workpiece-related data, machine-related data, etc., such as the total number of workpieces, the total number of machines, and the average number of available machines for workpieces. The workpiece-related data includes: the processing time of the current process for all workpieces, the remaining processing time for all workpieces, the remaining processing time for all workpieces except the current process, the processing time of the subsequent process for all workpieces, the total processing time for all workpieces, etc. The machine-related data includes: the utilization rate of each machine, the number of the machine, and the index of the machine in the candidate machines.

The obtaining of the output values includes: setting weight coefficients for different objective demands in the input indicators, and obtaining an optimal weight coefficient combination that balances the plurality of objective demands through an experiment of different objective weight coefficients; and using a plurality of objective weight coefficients in the optimal weight coefficient combination as the output values.

In other words, the objective weight coefficient of each group of production data is determined through experiments, the optimal solution that can balance the plurality of objective demands is found, and these objective weight coefficients are output.

A method for determining an objective weight coefficient is described by taking a dual-objective multi-robot collaborative processing problem as an example. The objective demand (the objective function) is to minimize the completion time and minimize the number of collaborative robots, and the objective weight coefficients thereof are w1 and w2, respectively. First, for each objective demand, a single-objective mixed-integer linear programming model is established for solving and obtaining an objective benchmark value. Then, in a parameter space of [w1: 0.1-0.9, w2: 0.1-0.9], random sampling is used to generate 256 groups of objective weight combinations. A high-quality solution that satisfies that the change in the benchmark value of the completion time is less than 3% and the change in the number of collaborative robots is less than 30% is screened out, so as to establish the mapping relationship between the input indicators and the high-quality objective weight.

In S202, a large model is trained by using the mapping relationship; the input indicators and the plurality of objective weight coefficients output correspondingly are input into the large model by using a supervised fine-tuning method; training parameters are continuously adjusted to obtain the large model for multi-objective weight optimization.

In other words, in the training process, the input data and the corresponding output objective weight coefficients are input into the large model by using a supervised fine-tuning method, and the large model can accurately predict the objective weight coefficients by adjusting the training parameters. When the user inputs new prompt information, a plurality of objective demands can be automatically extracted, and the large model for multi-objective weight optimization can automatically output a reasonable objective weight coefficient according to the plurality of objective demands based on learned knowledge, so as to achieve the intelligent modeling of multi-objective job shop scheduling.

Supervised fine-tuning training is performed on the large model for multi-objective weight optimization. As an embodiment, the large model for multi-objective weight optimization may select lightweight Meta-Llama-3-8B-Instruct to be deployed locally, and the training parameters of the large model are adjusted, such that the large model can accurately predict a reasonable objective weight coefficient from the input indicators.

In Step 103, constraint conditions are extracted from the job shop modeling prompt information by using a large model for mathematical modeling, and modeling is performed based on the plurality of objective weight coefficients and the constraint conditions to obtain a multi-objective mathematical model.

As an embodiment, the establishment of the large model for mathematical modeling includes: collecting a plurality of problem descriptions about the job shop modeling prompt information and corresponding job shop types, and using prompt words to enable a cloud-based large model to perform fuzzification processing on the problem descriptions, so as to obtain a sample dataset; and using the sample dataset to perform supervised fine-tuning on a large model to enhance the understanding and judgment of the large model on the fuzzy descriptions, so as to obtain the large model for mathematical modeling.

With the assistance of a job shop scheduling knowledge base, the large model for mathematical modeling performs mathematical modeling on the plurality of objective weight coefficients and the constraint conditions based on the modeling knowledge stored in the job shop scheduling knowledge base, and displays the objective weight coefficients, the constraint conditions, variables, and mathematical formulas on a front-end interface.

As an embodiment, the obtaining of the multi-objective mathematical model includes:
obtaining a plurality of groups of corresponding constraint conditions according to the plurality of objective demands, and constructing a plurality of mathematical sub-models according to a single objective demand and corresponding constraint conditions separately; and
obtaining the multi-objective mathematical model by using the plurality of objective weight coefficients and the plurality of corresponding mathematical sub-models.

It should be noted that one objective demand corresponds to one mathematical sub-model.

Further, the obtaining of the mathematical sub-models includes:
establishing a job shop scheduling knowledge base, where the job shop scheduling knowledge base includes: problem definitions, variable definitions, specification constraint conditions, and corresponding LaTeX formulas of job shop scheduling; and
based on the modeling knowledge stored in the job shop scheduling knowledge base, mapping the constraint conditions after fuzzification processing to the specification constraint conditions in the job shop scheduling knowledge base by using the large model for mathematical modeling through retrieval, matching, and adaptation operations, and then transforming the specification constraint conditions into LaTeX formulas conforming to the specifications of the mixed-integer linear programming model.

It should be noted that the front-end interactive interface may have a preset prompt information standard template or guide the user to input the detailed description of the job shop scheduling by establishing a large model for data processing, where the detailed description includes job shop scheduling scenario information, job shop production information, and production objective demand information, such as the number of processes, machine selection, processing constraints, and other information. The user supplements and adjusts the job shop modeling prompt information by checking the constraint conditions and the objective demands or continuing the dialogue. After multiple rounds of interaction, the job shop modeling prompt information meeting requirements is obtained, and then the objective demands and the constraint conditions are extracted and displayed on the front-end interactive interface.

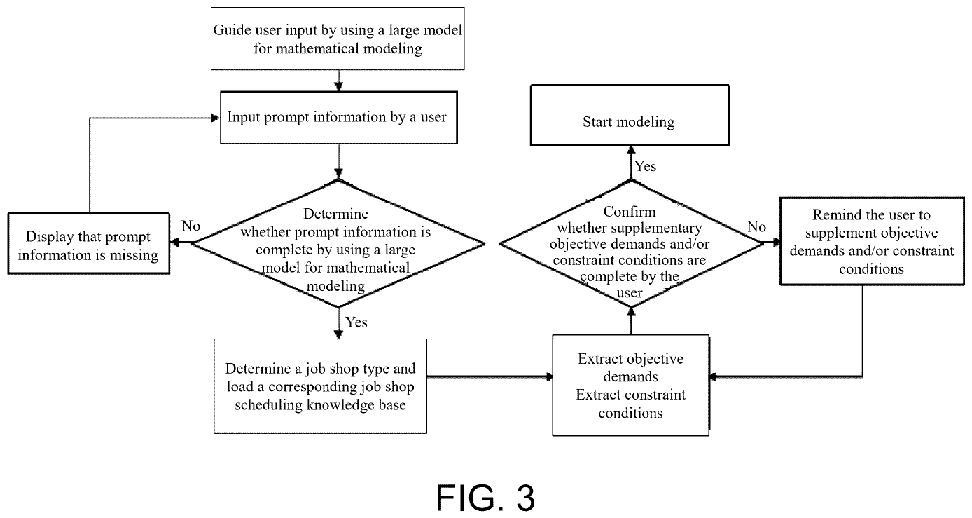

FIG. 3 is a flowchart of a front-end interactive interface confirming whether prompt information meets requirements through multiple rounds of interaction with a user. DeepSeek-R1-Distill-Qwen-32B deployed locally is selected as the large model for mathematical modeling and subjected to supervised fine-tuning by using a fuzzy description-constraint dataset. The large model for mathematical modeling determines whether the prompt information input by the user is complete, and if the prompt information is incomplete, the user is reminded to supplement missing information; if the prompt information is complete, a job shop type is further determined and a corresponding job shop scheduling knowledge base is loaded. The large model for multi-objective weight optimization extracts objective demands, and the large model for mathematical modeling with the job shop scheduling knowledge base extracts constraint conditions; the user determines whether the objective demands and the constraint conditions meet requirements, and if the objective demands and the constraint conditions do not meet the requirements, the user is reminded to supplement the objective demands and the constraint conditions; if the objective demands and the constraint conditions meet the requirements, modeling is performed based on the plurality of objective weight coefficients and the constraint conditions to obtain a multi-objective mathematical model. It should be noted that each job shop type corresponds to one job shop scheduling knowledge base.

For example, the user inputs: “I have a batch of workpieces that are processed on some machines, the processes for the workpieces are different, and there are a plurality of available machines for each process; the objective is to minimize the completion time, please help me model.” The large model may determine that the scenario described by the user is a flexible job shop scheduling problem (FJSP) according to “the processes are different” and “a plurality of available machines”, and load the corresponding FJSP job shop scheduling knowledge base. The FJSP job shop scheduling knowledge base includes the problem definition, variable definition, specification constraint conditions, and related formula information of the FJSP.

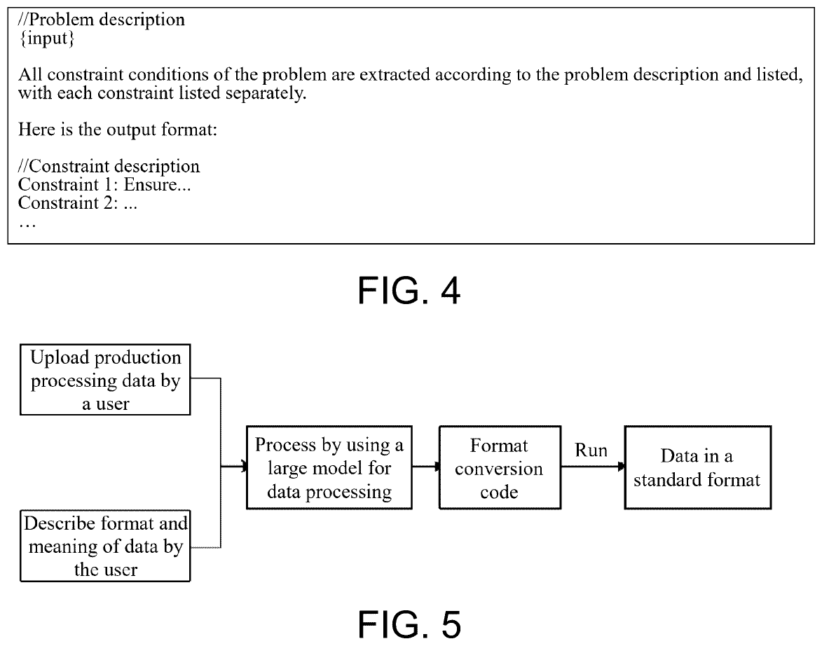

With the assistance of the job shop scheduling knowledge base, the large model for mathematical modeling converts the prompt information input by the user into constraint conditions in a standardized form by using the prompt word framework as shown in FIG. 4, and displays the constraint conditions on the front-end interface. The user checks and supplements the constraint conditions. For example, the user supplements that “the last completion time for workpiece 1 is the same as that for workpiece 2”, and then the large model for mathematical modeling may display the newly supplemented constraint conditions on the front-end interface.

The prompt information (job shop modeling prompt information or dynamic prompt information) includes job shop scheduling scenario information, job shop production information, production objective demand information, and production processing data.

The job shop scheduling scenario information, the production constraint information, and the production objective demand information are input into the large model for mathematical modeling, constraint conditions are extracted, and the multi-objective mathematical model is established.

The production processing data is used to be input into the large model for multi-objective weight optimization to extract a plurality of objective demands, so as to obtain a plurality of objective weight coefficients, and is used to solve the multi-objective mathematical model.

It should be noted that the production processing data uploaded by the user needs to be converted into a standard format by using a standard data template or a large model for data processing. After the multi-objective mathematical model is converted into code, the code needs to be executed to invoke the production processing data for solving. The production processing data is converted into a standard format to match the data interface of the code, thereby preventing an error in the solving process.

As shown in FIG. 5, the user uploads data in a non-standard format and describes the meaning. In this case, the large model for data processing may generate code to transform the uploaded data into the standard format.

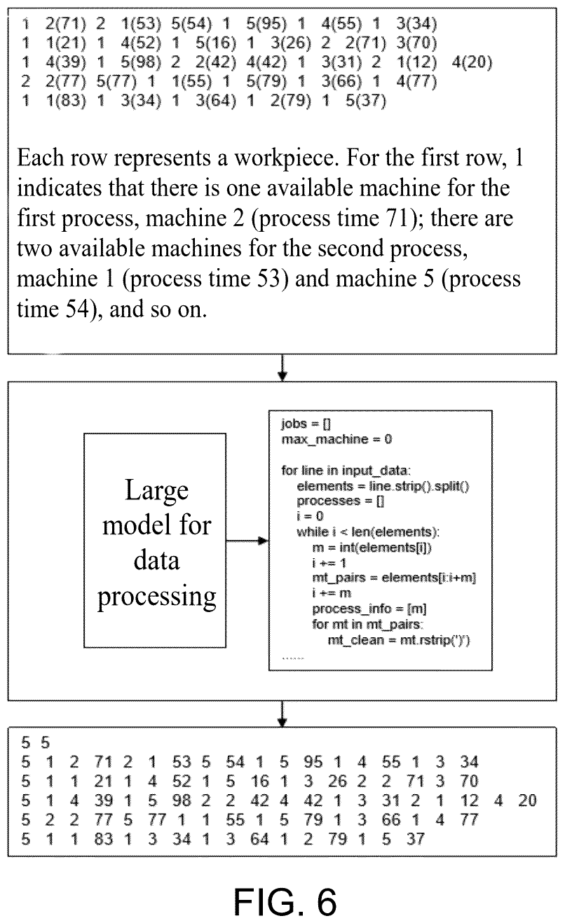

For example, a lightweight code model Qwen2.5-Coder-7B-Instruct is deployed locally as the large model for data processing. FIG. 6 shows an example of data format conversion. The user provides data in a non-standard format for the FJSP, and describes the meaning represented by the data, including a workpiece, a process, a machine, processing time, and the like. Then, the large model for data processing generates code, and converts the data in the non-standard format into the standard format by using the code, thereby facilitating subsequent solving.

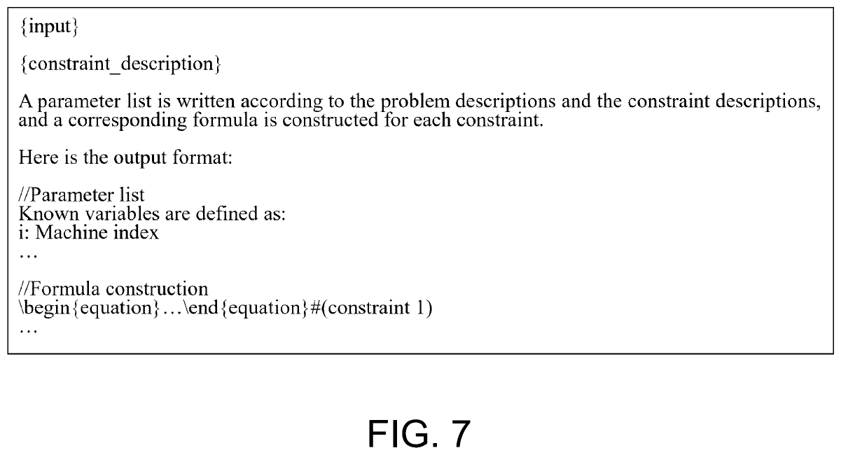

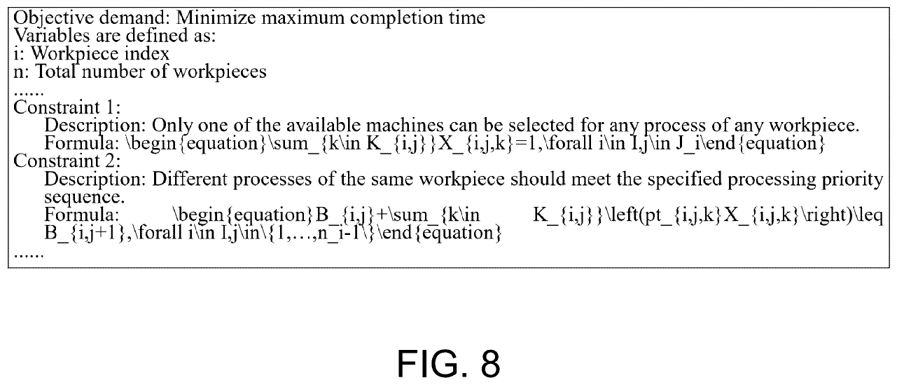

After the objective weight coefficients and the constraint conditions are extracted, the user clicks to confirm the modeling. The large model for mathematical modeling uses the modeling prompt word framework as shown in FIG. 7 to perform mathematical modeling on the plurality of objective weight coefficients and the extracted constraint conditions with the assistance of the job shop scheduling knowledge base, thereby obtaining variable definitions and formulas, which are displayed on the front-end interface, as shown in FIG. 8.

It should be noted that when the plurality of objective demands are extracted, the multi-objective mathematical model is established through the collaboration of the two large models, the large model for multi-objective weight optimization and the large model for mathematical modeling. The large model for multi-objective weight optimization allocates a reasonable objective weight coefficient based on the prompt information input by the user. The large model for mathematical modeling sets the objective demands as a multi-objective function with the objective weight coefficient to be determined, thereby obtaining the multi-objective mathematical model.

In step 104, the multi-objective mathematical model is solved to output a job shop scheduling result.

Specifically, the solving includes: transforming the multi-objective mathematical model into code by using a large model for code construction after supervised fine-tuning, converting LaTeX formulas into Python code by using specific prompt words, and running the Python code by using a solver for solving.

The lightweight Qwen2.5-Coder-7B-Instruct large model deployed locally is used as the large model for code construction. A supervised fine-tuning (SFT) sample dataset may be constructed by collecting formulas of job shop scheduling and corresponding code, and a large model for code construction is fine-tuned to enhance the code writing capability thereof. As an embodiment, the construction of the large model for code construction includes: constructing a fine-tuning sample dataset by using a plurality of prompt words and correct code, and performing supervised fine-tuning on the large model for code construction to improve the code writing accuracy thereof.

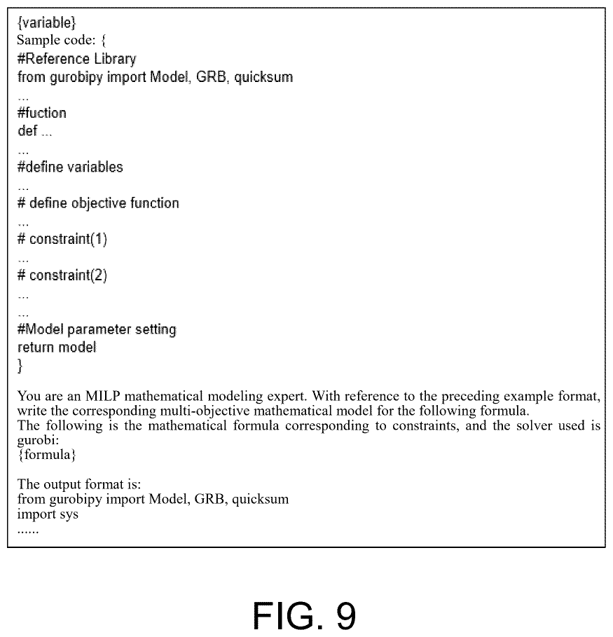

For example, code construction prompt words as shown in FIG. 9 may be used; code structure examples, output formats, and the like are provided; the variable definitions and LaTeX formulas obtained from the multi-objective mathematical model are filled into the prompt words. The large model for code construction can accurately convert the variable definitions and LaTeX formulas in the multi-objective mathematical model into Python code that can be recognized and executed by the Gurobi solver.

The Gurobi solver runs the Python code for solving and displays a solving log on the front-end interface. The solving log includes key information in the solving process, such as solving time, the number of iterations, and a change in the objective function value. The user can view the solving log to know the production scheduling result, including the processing task schedule for each machine, order delivery time, and other information.

In step 105, a job shop dynamic event is monitored in real time, dynamic prompt information input by the user is received, the objective weight coefficients are dynamically updated by using the large model for multi-objective weight optimization, the constraint conditions are dynamically updated by using the large model for mathematical modeling, continuous updating is performed to obtain a new multi-objective mathematical model, and solving is performed to output a new job shop scheduling result, thereby achieving the dynamic adjustment of job shop scheduling.

In other words, when a dynamic event occurs, the user inputs the fuzzy description of the dynamic event through the front-end interactive interface, and selects whether to input new data based on the type of the dynamic event. Then, the large model for multi-objective weight optimization automatically updates the objective weight coefficient; the large model for mathematical modeling also automatically parses the fuzzy description into new constraint conditions, and correspondingly corrects the original multi-objective mathematical model to achieve the automatic adjustment of the model. At the same time, based on the monitored current processing condition and new data input by the user, the data used for solving is automatically updated, thereby completing automatic data conversion. Then, a new job shop scheduling result is obtained according to the solving method of step S104, thereby achieving the dynamic adjustment of job shop scheduling.

As an embodiment, the dynamic adjustment further includes the following steps.

In S501, when the multi-objective mathematical model is updated, the large model for mathematical modeling retrieves the original constraint conditions, determines the adjustment method as retaining, modifying, or adding, and updates only part of the constraint conditions that have been changed.

In S502, when the solving data is updated, the to-be-processed data of incomplete processes in the current job shop scheduling is frozen, the processing data of the completed processes is removed, and a new job shop scheduling result is output according to the dynamic prompt information input by the user and the to-be-processed data.

When a dynamic event occurs, the large model for objective weight optimization automatically extracts the objective demands according to the dynamic prompt information newly input by the user, reinvokes the large model for multi-objective weight optimization, and automatically updates the objective weight coefficients.

When a dynamic event occurs, the large model for mathematical modeling automatically adjusts the multi-objective mathematical model according to the fuzzy description input by the user, and also automatically updates the data used for solving. The user inputs the fuzzy description of the dynamic event through the front-end interactive interface, and selects whether to input new data based on the type of the dynamic event.

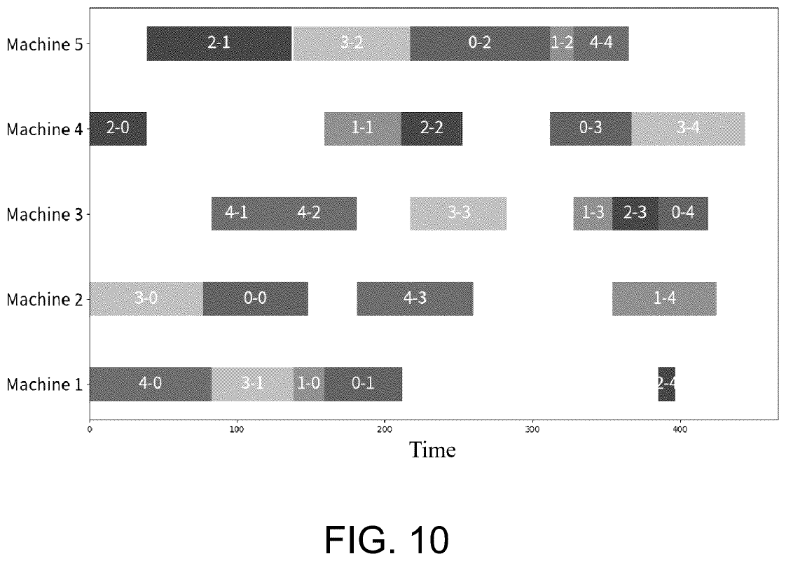

The specific workflow of dynamic event processing is described by taking a machine failure as an example. FIG. 10 is a Gantt chart of production scheduling results obtained through the foregoing steps. When the time is 100, machine 2 suddenly fails, and the user inputs “machine 2 fails, and the estimated maintenance time is 20” as the description information through the interface. The system then freezes the current processing status data and discards the data of processes 2-0, 3-0, 4-0 where processing is completed; for processes 2-1, 3-1, 4-1 where processing is in progress on normal machines, the processing continues, and the time for completing processing of these processes is used as the data of the machine's available start time. For the failed machine 2, the processes thereof need to be reprocessed. The machine failure involves damaged and undamaged workpieces. If the workpiece is undamaged, whether the processing time changes should be set according to the specific situation. Here, only the case of a damaged workpiece is considered, so workpiece 0 needs to be reprocessed from process 0.

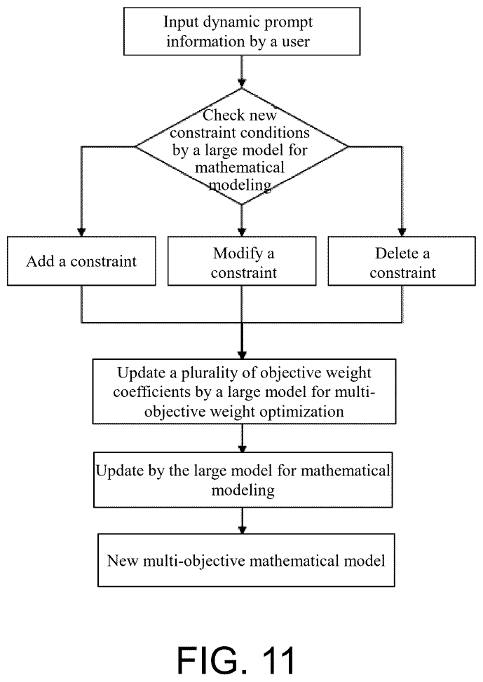

The process of automatic adjustment of the multi-objective mathematical model is as shown in FIG. 11. The large model for mathematical modeling automatically parses the fuzzy description into new constraint conditions, and correspondingly corrects the original multi-objective mathematical model by adding, modifying, and deleting constraints, thereby achieving the automatic adjustment of the multi-objective mathematical model.

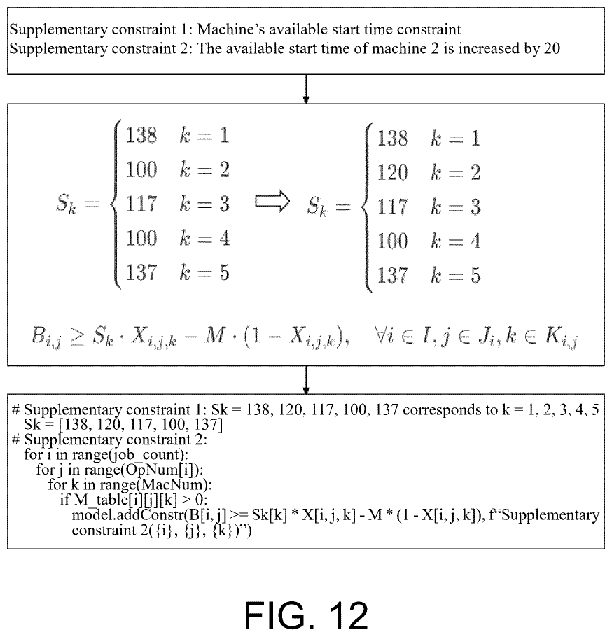

As shown in FIG. 12, based on the machine failure information input by the user, the large model for mathematical modeling uses the available start times 138, 100, 117, 100, 137 of machines 1-5 as the supplementary constraints, and supplements a constraint condition “the available start time of machine 2 is increased by 20”. Then, the large model for mathematical modeling generates a corresponding mathematical formula based on the new constraint conditions, and adds the mathematical formula to the original multi-objective mathematical model. Finally, the large model for code construction is switched to, so as to generate new code for solving.

Based on the monitored current processing condition of the job shop and the dynamic prompt information input by the user, the data used for solving is automatically updated to complete automatic data conversion.

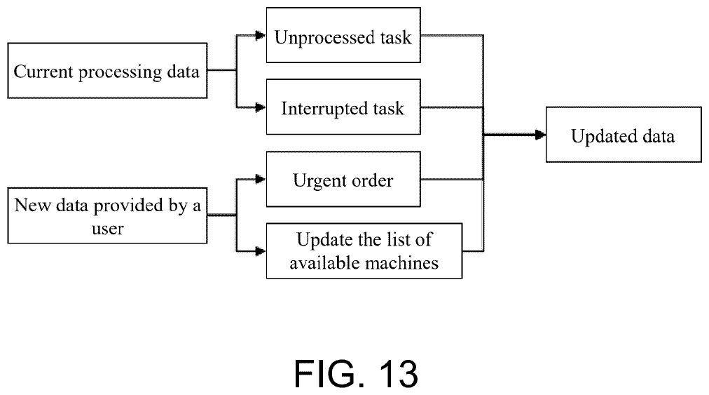

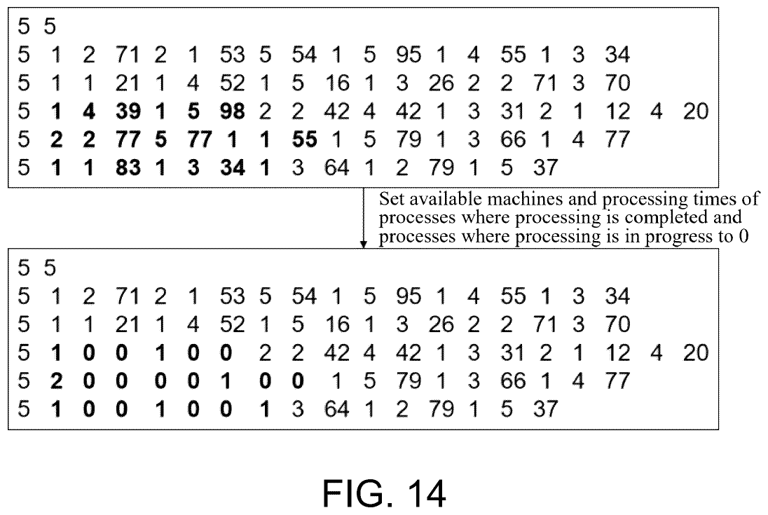

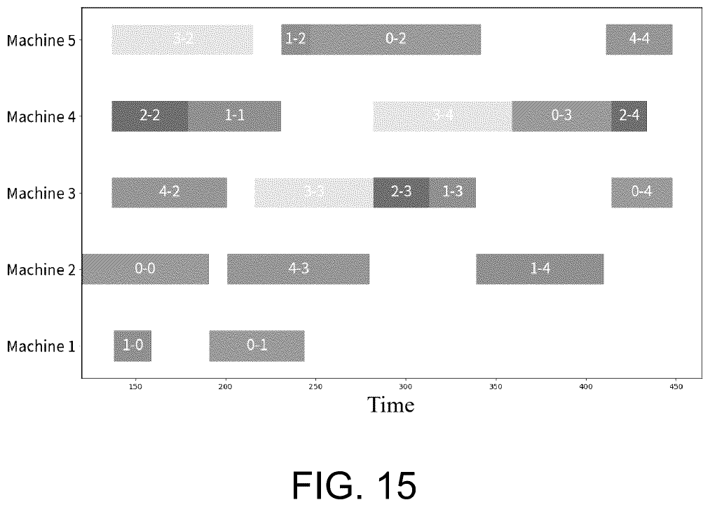

As shown in FIG. 13, the system freezes the current processing status data, removes the data of completed processes, and generates a new dataset by combining the new data input by the user and the data of incomplete processes. As shown in FIG. 14, the data format of the FJSP is as follows: The first row represents five workpieces and five machines. For the second to sixth rows, each row corresponds to the machine selection and processing time information of one workpiece. Taking the fifth row “5 2 2 77 5 77 1 1 55 1 5 79 1 3 66 1 4 77” as an example, the first 5 indicates that the workpiece has five processes, “2 2 77 5 77” indicates that the number of available machines in the first process is two, which are machine 2 (processing time 77) and machine 5 (processing time 77), respectively, and “1 1 55” indicates that the number of available machines in the second process is one, which is machine 1 (processing time 55), thereby obtaining the data of available machines and processing times of the five processes. When machine 2 fails, the time is 100; the available machines and processing times of processes 2-0, 3-0, 4-0 where processing is completed and processes 2-1, 3-1, 4-1 where processing is in progress are set to 0, such that the number of the processes can be kept without affecting the production scheduling of the unprocessed processes. Then, the updated data is used for solving to obtain a new production scheduling result, and the new job shop scheduling result is displayed on the front-end interface, as shown in FIG. 15.

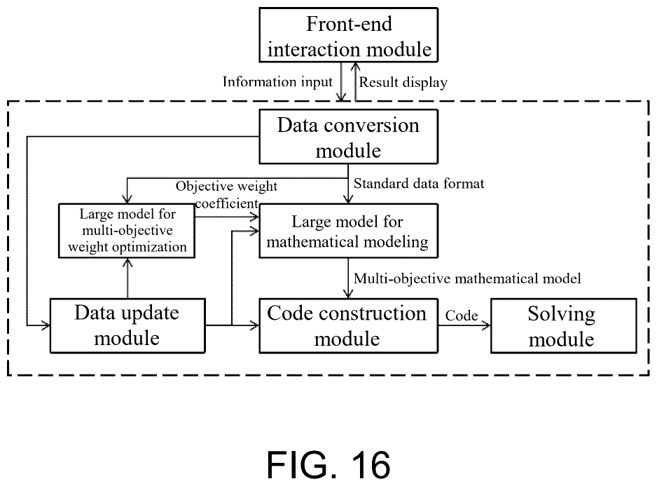

In a second aspect, the present disclosure further provides a system for dynamic adjustment of multi-objective job shop scheduling based on large models, configured to perform the steps of the method according to any one of the above embodiments. As shown in FIG. 16, the system includes a front-end interaction module, a data conversion module, a large model for multi-objective weight optimization, a large model for mathematical modeling, a code construction module, a solving module, and a data update module.

The front-end interaction module is configured to receive job shop modeling prompt information or dynamic prompt information input by a user, implement information interaction between the user and the system, and display a model construction process, a solving log, and a job shop scheduling result.

Further, the front-end interaction module includes a guide input unit, an information display unit, and an interaction control unit.

The guide input unit is configured to provide a prompt of common constraint types and a standard data template for the user, so as to facilitate the user's accurate description of job shop scheduling scenario information, job shop production information, and production objective demand information.

The information display unit is configured to present the constraint adjustment in a standardized form, the variables and formulas of the multi-objective mathematical model, the solving log, and the final job shop scheduling result in various forms for easy understanding by the user.

The interaction control unit is configured to support the user in performing multiple rounds of interactive checks, supplements, and adjustments on the constraint conditions and the objective demands, and selecting whether to input new data based on the type of a dynamic event, thereby achieving the efficient interaction between the user and the system.

The data conversion module is configured to automatically convert the production processing data in the job shop modeling prompt information or the dynamic prompt information from a non-standard format into a standard data format. The data conversion module includes a data reception unit, a data parsing unit, a data conversion unit, and a data storage unit.

The data reception unit is configured to acquire the job shop modeling prompt information or the dynamic prompt information input by the user, whether in a standard template format or the non-standard format.

The data parsing unit is configured to parse data in the non-standard format to identify the format and meaning of the data.

The data conversion unit is configured to generate code by using a large model for data processing based on the format and meaning of the data, and convert the data in the non-standard format into the standard format.

The data storage unit is configured to store the converted data in the standard format for subsequent modeling and solving.

The large model for multi-objective weight optimization is configured to extract a plurality of objective demands from the job shop modeling prompt information, and determine a plurality of objective weight coefficients corresponding to the plurality of objective demands.

The large model for mathematical modeling is configured to extract constraint conditions from the job shop modeling prompt information, and perform modeling based on the plurality of objective weight coefficients and the constraint conditions to obtain a multi-objective mathematical model, and includes a job shop scheduling knowledge base, a constraint transformation unit, and a model construction unit.

The job shop scheduling knowledge base includes problem definitions, variable definitions, specification constraint conditions, and corresponding LaTeX formulas of shop scheduling.

The constraint transformation unit is configured to receive the modeling prompt information transmitted by the front-end interaction module, extract constraint conditions, map the constraint conditions after fuzzification processing to the specification constraint conditions in the job shop scheduling knowledge base through retrieval, matching, and adaptation operations, and then transform the specification constraint conditions into LaTeX formulas conforming to the specifications of the mixed-integer linear programming model.

The model construction unit is configured to perform mathematical modeling on the objective weight coefficients and the constraint conditions based on the modeling knowledge in the job shop scheduling knowledge base, construct a multi-objective mathematical model including constraints, variables, and formulas, and transmit the multi-objective mathematical model to the front-end interaction module for display and the code construction module for subsequent processing.

The code construction module is configured to transform the multi-objective mathematical model into executable code, and includes a code generation unit and a model update unit.

The code generation unit converts the LaTeX formulas of multi-objective mathematical modeling into Python code that can be recognized and executed by the Gurobi solver by using specific prompt words and using a supervised fine-tuning method, so as to ensure the accuracy and standardization of the code.

The model update unit is configured to, when a dynamic event occurs, receive new constraint conditions transmitted by the large model for mathematical modeling, correct the original multi-objective mathematical model, then update the generated new Python code, and transmit the new Python code to the solving module for solving, so as to adapt to a dynamic change in job shop scheduling.

The solving module is configured to solve the executable code, receive the Python code transmitted by the code construction module, run the code for solving, record a solving log, feed back the solving log to the front-end interaction module for display, and transmit a production scheduling result to the front-end interaction module after the solving is completed.

The data update module is configured to, when a dynamic event occurs, based on the current processing condition and the dynamic prompt information input by the user, freeze the current processing status data, remove completed process data, and generate a new dataset by combining new data and incomplete process data, so as to provide accurate data support for model solving and ensure the reliability of a solving result.

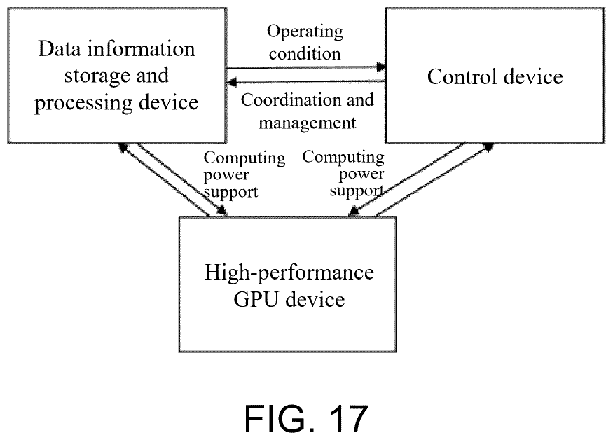

In a third aspect, the present disclosure further provides an apparatus for dynamic adjustment of multi-objective job shop scheduling based on large models, configured to perform the steps of the method according to any one of the above embodiments. As shown in FIG. 17, the apparatus includes a data information storage and processing device, a high-performance graphics processing unit (GPU) device, and a control device.

The data information storage and processing device is configured to store a large model for multi-objective weight optimization, a large model for mathematical modeling, and a large model for code construction after supervised fine-tuning, and a job shop scheduling knowledge base, and run a modeling and code conversion program.

The high-performance GPU device is configured to provide the necessary computing power support for the inference, fine-tuning, and training processes of large models.

The control device is configured to coordinate and manage the operation of the entire apparatus, including starting, stopping, monitoring the operating status of each device, and handling abnormal situations.

In conclusion, the present disclosure discloses a method, a system, and an apparatus for dynamic adjustment of multi-objective job shop scheduling based on large models. According to the present disclosure, job shop modeling prompt information input by a user is acquired through a front-end interactive interface; a multi-objective weight coefficient adaptive adjustment mechanism is introduced, a plurality of objective demands are extracted from the job shop modeling prompt information, and a plurality of objective weight coefficients corresponding to the plurality of objective demands are determined; constraint conditions are extracted by using a large model for mathematical modeling after supervised fine-tuning, a multi-objective mathematical model is constructed based on the plurality of objective weight coefficients and the constraint conditions, and solving is performed to output a job shop scheduling result; when a dynamic event occurs, the user inputs a dynamic event description through the front-end interactive interface, each large model automatically updates the model and data, and re-solving is performed to obtain a new production scheduling result. The present disclosure features functions such as automatic model adjustment, automatic data conversion, and multi-objective demand adaptive modeling, which can solve the problem that the current job shop scheduling cannot adapt to complex and changeable actual dynamic production environments and lacks the capability for automatic processing of multi-objective demands, and bring new breakthroughs and development to the field of job shop scheduling.

It should be noted that for ease of description, each of the aforementioned embodiments is expressed as a series of combinations of actions, but those skilled in the art should recognize that the present application is not limited by the described action order, as certain steps may be performed in other orders or simultaneously according to the present application. Then, those skilled in the art should recognize that the embodiments described in this specification are all preferred embodiments, and the actions and modules involved are not necessarily required in the present application.

In the above embodiments, the description of each embodiment has respective focuses. For a part that is not described in detail in an embodiment, reference can be made to related descriptions in other embodiments.

In the several embodiments provided in the present application, it should be understood that the disclosed method or system may be implemented in other manners. For example, the above-described embodiments are merely illustrative. For example, the division of the units is only a logical functional division, and in actual implementation, there may be other division methods. For example, a plurality of units or components may be combined or integrated into another system, or some features may be omitted or not executed.

The units described as separate parts may or may not be physically separate, and parts displayed as units may or may not be physical units, that is, they may be located in one place or distributed across a plurality of network units. Some or all of the units may be selected according to actual needs to achieve the purpose of the solutions of the embodiments.

In addition, various functional units in the embodiments of the present application may be integrated into one processing unit, or various units may be physically present separately, or two or more units may be integrated into one unit. The integrated unit may be implemented in the form of hardware, or in the form of a software functional unit.

The integrated unit may be stored in a computer-readable memory if it is implemented in the form of a software functional unit and sold or used as an independent product. Based on such understandings, the technical solutions of the present application substantially, or the part thereof that contributes to the prior art, or all or part of the technical solutions, may be embodied in the form of a software product. The computer software product is stored in a memory and includes several instructions for causing a computer device (which may be a personal computer, a server, or a network device) to perform all or part of the steps of the methods as defined in the embodiments of the present application.

Those of ordinary skill in the art should understand that all or part of the circuits in the above embodiments can be completed by instructing relevant hardware through a program. The program may be stored in a computer-readable memory, and the memory may include: a flash disk, a read-only memory (ROM), a random access memory (RAM), a magnetic disk, an optical disc, or the like.

The above descriptions are merely exemplary embodiments of the present disclosure and are not intended to limit the scope of the present disclosure. That is, all equivalent changes and modifications made in accordance with the teachings of the present disclosure are still within the scope of the present disclosure. Other embodiments of the present disclosure are apparent to those skilled in the art from consideration of the specification and practice of the present disclosure. The present application is intended to cover any variations, uses, or adaptations of the present disclosure following the general principles of the present disclosure and including known common knowledge or customary technical means not described in the art of the present disclosure. The specification and embodiments are only considered as exemplary, and the scope and spirit of the present disclosure are defined by the claims.

The technical features of the above embodiments may be arbitrarily combined. For the sake of concise description, not all possible combinations of the technical features in the above embodiments have been described. However, as long as there is no contradiction between the combinations of these technical features, they should be considered as falling within the scope of the specification.

Those skilled in the art will readily understand that the above descriptions are merely preferred embodiments of the present disclosure and are not intended to limit the present disclosure. Any modifications, equivalents, improvements, and the like made within the spirit and principle of the present disclosure shall fall within the protection scope of the present disclosure.

What is claimed is:

1. A method for dynamic adjustment of multi-objective job shop scheduling based on large models, comprising:
receiving job shop modeling prompt information input by a user;
extracting a plurality of objective demands from the job shop modeling prompt information by using a large model for multi-objective weight optimization, and determining a plurality of objective weight coefficients corresponding to the plurality of objective demands;
extracting constraint conditions from the job shop modeling prompt information by using a large model for mathematical modeling, and performing modeling based on the plurality of objective weight coefficients and the constraint conditions to obtain a multi-objective mathematical model;
solving the multi-objective mathematical model to output a job shop scheduling result; and
monitoring a job shop dynamic event in real time, receiving dynamic prompt information input by the user, dynamically updating the objective weight coefficients by using the large model for multi-objective weight optimization, dynamically updating the constraint conditions by using the large model for mathematical modeling, continuously updating to obtain a new multi-objective mathematical model, and solving to output a new job shop scheduling result, thereby achieving dynamic adjustment of job shop scheduling.

2. The method for dynamic adjustment of multi-objective job shop scheduling based on large models according to claim 1, wherein establishment of the large model for multi-objective weight optimization comprises:
generating a fine-tuning dataset, wherein the fine-tuning dataset comprises a plurality of groups of input indicators and output values with a mapping relationship, wherein
obtaining of the input indicators comprises: collecting a sample dataset of a plurality of job shop schedules and the plurality of objective demands corresponding to the sample dataset, generating the job shop scheduling result corresponding to the sample dataset by using a plurality of job shop scheduling rules, and extracting dataset features from the job shop scheduling result; and taking the dataset features and the plurality of corresponding objective demands as the input indicators; and
obtaining of the output values comprises: setting weight coefficients for different objective demands in the input indicators, and obtaining an optimal weight coefficient combination that balances the plurality of objective demands through an experiment of different objective weight coefficients; and using a plurality of objective weight coefficients in the optimal weight coefficient combination as the output values; and
training a large model by using the mapping relationship, inputting the input indicators and the plurality of objective weight coefficients output correspondingly into the large model by using a supervised fine-tuning method, and continuously adjusting training parameters to obtain the large model for multi-objective weight optimization.

3. The method for dynamic adjustment of multi-objective job shop scheduling based on large models according to claim 1, wherein the dynamic adjustment further comprises:
when updating the multi-objective mathematical model, retrieving original constraint conditions, determining an adjustment method as retaining, modifying, or adding, and updating only part of the constraint conditions that have been changed, by the large model for mathematical modeling; and
when updating solving data, freezing to-be-processed data of incomplete processes in current job shop scheduling, removing processing data of completed processes, and outputting a new job shop scheduling result according to the dynamic prompt information input by the user and the to-be-processed data.

4. The method for dynamic adjustment of multi-objective job shop scheduling based on large models according to claim 2, wherein obtaining of the multi-objective mathematical model comprises:
obtaining a plurality of groups of corresponding constraint conditions according to the plurality of objective demands, and constructing a plurality of mathematical sub-models according to a single objective demand and corresponding constraint conditions separately; and
obtaining the multi-objective mathematical model by using the plurality of objective weight coefficients and the plurality of corresponding mathematical sub-models.

5. The method for dynamic adjustment of multi-objective job shop scheduling based on large models according to claim 4, wherein obtaining of the mathematical sub-model comprises:
establishing a job shop scheduling knowledge base, wherein the job shop scheduling knowledge base comprises: problem definitions, variable definitions, specification constraint conditions, and corresponding LaTeX formulas of job shop scheduling; and
based on modeling knowledge stored in the job shop scheduling knowledge base, mapping the constraint conditions after fuzzification processing to specification constraint conditions in the job shop scheduling knowledge base by using the large model for mathematical modeling through retrieval, matching, and adaptation operations, and then transforming the specification constraint conditions into LaTeX formulas conforming to specifications of a mixed-integer linear programming model.

6. The method for dynamic adjustment of multi-objective job shop scheduling based on large models according to claim 1, wherein establishment of the large model for mathematical modeling comprises:
collecting a plurality of problem descriptions about the job shop modeling prompt information and corresponding job shop types, and using prompt words to enable a cloud-based large model to perform fuzzification processing on the problem descriptions, so as to obtain a sample dataset; and
using the sample dataset to perform supervised fine-tuning on a large model to enhance understanding and judgment of the large model on fuzzy descriptions, so as to obtain the large model for mathematical modeling.

7. The method for dynamic adjustment of multi-objective job shop scheduling based on large models according to claim 3, wherein solving the multi-objective mathematical model comprises:
transforming the multi-objective mathematical model into code by using a large model for code construction after supervised fine-tuning, converting LaTeX formulas into Python code by using specific prompt words, and running the Python code by using a solver for solving.

8. The method for dynamic adjustment of multi-objective job shop scheduling based on large models according to claim 7, wherein the job shop modeling prompt information comprises at least: job shop scheduling scenario information, job shop production information, production objective demand information, and production processing data.

9. A system for dynamic adjustment of multi-objective job shop scheduling based on large models, configured to perform steps of the method according to claim 1, wherein the system comprises:
a front-end interaction module, configured to receive the job shop modeling prompt information or the dynamic prompt information input by the user, implement information interaction between the user and the system, and display a model construction process, a solving log, and the job shop scheduling result;
a data conversion module, configured to automatically convert production processing data in the job shop modeling prompt information or the dynamic prompt information from a non-standard format into a standard data format;
the large model for multi-objective weight optimization, configured to extract the plurality of objective demands from the job shop modeling prompt information, and determine the plurality of objective weight coefficients corresponding to the plurality of objective demands;
the large model for mathematical modeling, configured to extract the constraint conditions from the job shop modeling prompt information, and perform modeling based on the plurality of objective weight coefficients and the constraint conditions to obtain the multi-objective mathematical model;
a code construction module, configured to transform the multi-objective mathematical model into executable code;
a solving module, configured to solve the executable code; and
a data update module, configured to, when a dynamic event occurs, based on a current processing condition and the dynamic prompt information input by the user, freeze current processing status data, remove completed process data, and generate a new dataset by combining new data and incomplete process data, so as to provide accurate data support for model solving and ensure reliability of a solving result.

10. An apparatus for dynamic adjustment of multi-objective job shop scheduling based on large models, configured to perform steps of the method according to claim 1, and comprising a data information storage and processing device, a high-performance graphics processing unit (GPU) device, and a control device.
